(19) United States
(12) Patent Application Publication
(10) Pub. No.: US 2009/0257609 A1
(43) Pub. Date: Oct. 15, 2009

(54) Method for Noise Reduction and Associated Hearing Device

(76) Inventors: Timo Gerkmann, Bochurn (DE); Rainer Martin, Bochum (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/489,910

(22) Filed: Jun. 23, 2009

(30) Foreign Application Priority Data
Jan. 7, 2008 (DE) 10 2008 031 150.2

(51) Int. Cl. H04R 25/00

(52) U.S. Cl. 381/317

(57) ABSTRACT

The invention specifies a method for noise reduction of an input signal of a hearing device. The cepstrum coefficients of the input signal, of the changed input signal and/or of at least one parameter obtained from the input signal are modified. The modified cepstral coefficients are used for formation of an output signal from the input signal. The output signal has reduced noise in relation to the input signal. With instationary noises in particular, an estimation is improved and an improved auditive quality is achieved for the hearing device.

### CROSS REFERENCE TO RELATED APPLICATIONS

This application claims priority of German application No. 10 2008 031150.2 filed Jul. 1, 2008, which is incorporated by reference herein in its entirety.

### FIELD OF THE INVENTION

The invention relates to a method for noise reduction for a hearing device and to a hearing device with noise reduction.

### BACKGROUND OF THE INVENTION

Hearing devices are wearable hearing apparatus used to provide assistance those with impaired hearing. To meet the numerous individual requirements different designs of hearing device are provided, such as behind-the-ear hearing devices, with an external earpiece and in-the-ear hearing devices e.g. also Concha or in-canal hearing devices. The typical configurations of hearing device are worn on the outer ear or in the auditory canal. Above and beyond these designs however there are also bone conduction hearing aids, implantable or vibro-tactile hearing aids available on the market. In such hearing aids the damaged hearing is simulated either mechanically or electrically.

Hearing devices principally have as their main components an input converter, an amplifier and an output converter. The input converter is as a rule a sound receiver, e.g. a microphone, and/or an electromagnetic receiver, e.g. an induction coil. The output converter is mostly implemented as an electro acoustic converter, e.g. a miniature loudspeaker or as an electromechanical converter, e.g. bone conduction earpiece. The amplifier is usually integrated into a signal processing unit. This basic structure is shown in FIG. 1, using a behind-the-ear hearing device as an example. One or more microphones 2 for recording the sound from the surroundings are built into a hearing device housing 1 worn behind the ear. A signal processing unit 3, which is also integrated into the hearing device housing 1, processes the microphone signals and amplifies them. The output signal of the signal processing unit 3 is transmitted to a loudspeaker or earpiece 4 which outputs an acoustic signal. The sound is transmitted, if necessary via a sound tube, which is fixed with an otoplastic in the auditory canal, to the hearing device wearer's eardrum. The power is supplied to the hearing device and especially to the signal processing unit 3 by a battery 5 also integrated into the hearing device housing 1.

In the processing of digital speech recording, e.g. digital hearing devices, it is often desirable to suppress disruptive background noise without influencing the useful signal (speech). There are known filter methods suitable for this purpose which influence the short-term spectrum of the signal, such as the Wiener filters. However these methods require a precise estimation of the frequency-dependent power of the noise to be suppressed from an input signal. If this estimation is imprecise, either an unsatisfactory noise suppression is achieved, the desired signal is affected or additional artificially-created noise signals, so called “musical tones” occur. There are no methods for noise estimation yet available which solve these problems completely and efficiently.

Previously noise power has been able to be estimated principally using two approaches. Both methods can be undertaken either over a wide bandwidth or preferably in a frequency range split up by means of a filter bank or short-term Fourier transformation:

1. Speech Activity Detection:

Provided no speech activity is detected, the complete (time-variable) input signal power is regarded as noise. If speech activity is detected, the noise estimation is kept constant at the last value before the onset of the speech activity.

2. Noise Power Estimation During Speech Activity (the so Called “Minimum Tracking Method”):

It is known that during speech activity the speech signal power in individual frequency ranges is repeatedly briefly almost zero. If there is now an underlying mixture of speech and noise changing comparatively slowly over time, the minima of the spectral signal power considered over time correspond to the noise power at these times. The noise signal power must lie between the established minima (minimum tracking). Such a minimum tracking can for example be performed with the aid of a smoothing filter, which is described for example in R. Martin, “Noise power spectral density estimation based on optimal smoothing and minimum statistics”, IEEE Trans. Speech Audio Processing, Vol. 5, July 2001, Pages 504-512. The noise power is typically determined separately for different frequency ranges in the input signal. To this end the input signal is first split up by means of a filter bank or a Fourier transformation into individual frequency components. These components are then processed separately from one another.

In the above method 1, on the one hand the reliable detection of speech activity represents a problem, and on the other hand it is not possible to track noise which varies over time during simultaneous speech activity.

In the above method 2 there are fundamental contradictions in the setting of the algorithm to be resolved: If speech is present the noise estimation should only be adapted slowly in order not to classify speech components as noise through fast adaptation and affect the speech quality in this way. If there is no speech present, the noise power estimation should follow the temporal fine structure of the input signal without any delay. This produces conflicting demands for the setting parameters of the method, such as smoothing time constants, window length for a minimum search or weighting factors, which to date have only been able to be resolved averagely optimally. In addition this method is not in a position to track rapid changes in the noise signal.

A further option for enhancing speech and for suppression of “Musical Tones” is promised by “Cepstral smoothing” the weighting of spectral filters. C. Breithaupt et al., “Cepstral Smoothing of Spectral Filter Gains for Speech Enhancement Without Musical Noise”, IEEE Signal Processing Letters, Vol. 14, No. 12, December 2007, pages 1036 through 1039 describes that a recursive, temporary smoothing is essentially applied to higher cepstral coefficients, with each coefficient representing sound level information being removed. This method is also effective with non-stationary noise.

### SUMMARY OF THE INVENTION

The object of the present invention is now to specify a further method and a hearing device for an enhanced noise reduction, with speech in particular being less adversely affected and disruptive artifacts being avoided more effectively.

In accordance with the invention the given object is achieved with the method and with the hearing device of the independent claims.

Inventively the method for noise reduction of an input signal comprises a modification of the coefficients of the cepstrum of the input signal, of the changed input signal and/or of at least one parameter derived from the input signal, with cepstral coefficients replacement signal or of a parameter derived from the replacement signal being accepted depending on a specific point in time (this correspondence to an acceptance varying from point in time to point in time), as well as a use of the modified cepstral coefficients for forming an output signal from the input signal with the noise in the output signal being reduced in relation to the input signal.

In a further development the input signal can be obtained from an acoustic signal picked up by a hearing device.

In a further embodiment the method can comprise the following steps:
Formation of a noise power spectrum by estimating the interference noise of the input signal and/or
Formation of a speech power spectrum by estimating the speech of the input signal,
Determining the cepstrum of the noise power spectrum and/or
Determining the cepstrum of the speech power spectrum,
Determining modified cepstral coefficients for the cepstra of the noise power spectrum determined and/or of the speech power spectrum with the aid of a first replacement strategy,
Determining the modified spectra of the noise power and/or of the speech power from the modified cepstra and
Forming the noise-reduced output signal by modification of the spectral coefficients of the input signal by means of the modified spectra of the noise power and/or of the speech power.

Furthermore the method can comprise the following steps:
Forming the cepstrum of the input signal,
Determining modified cepstral coefficients for the cepstrum of the input signal determined with the aid of a second replacement strategy and
Forming a noise-reduced output signal from the modified cepstrum of the input signal.

In a further development the method can comprise the following additional steps:
Forming the cepstrum of the noise-reduced output signal,
Determining modified cepstral coefficients for the cepstrum of the noise-reduced output signal determined with the aid of the second replacement strategy and
Forming a further output signal from the modified cepstrum of the noise-reduced output signal, which is artifact-reduced in relation to the output signal.

The advantage of processing in the cepstral domain lies in the fact that coefficients can be determined robustly, which are predominantly dominated by speech. This allows the other coefficients to be assigned to the noise/interference. Speech can be broken down in the cepstral domain into the transmission function of the vocal tract and the excitation function. The information about the transmission function of the vocal tract is mapped onto the lower cepstral coefficient. With voiced sounds the information about the excitation function will essentially be reflected in a cepstral maximum in the upper cepstral range. The knowledge of the cepstral coefficients which are dominated by speech can be used as a-priori knowledge for a robust noise reduction or for reconstruction of a naturally sounding residual noise. In particular for the case of instationary noises an enhanced estimation and thus an enhanced auditive quality is possible.

Inventively a hearing device with noise reduction according to an inventive method is also specified. It comprises a signal processing unit with a noise power estimator, a speech power estimator and a first and/or second replacement unit for modification of cepstral coefficients.

The invention also claims a computer program product with a computer program featuring software means for executing the inventive method when the computer program is executed in an inventive hearing device.

### BRIEF DESCRIPTION OF THE DRAWINGS

Further special features and advantages of the invention are evident from the subsequent explanations of a number of exemplary embodiments which refer to schematic drawings.

The drawings show:

FIG. 1: a basic structure of a prior-art hearing device,

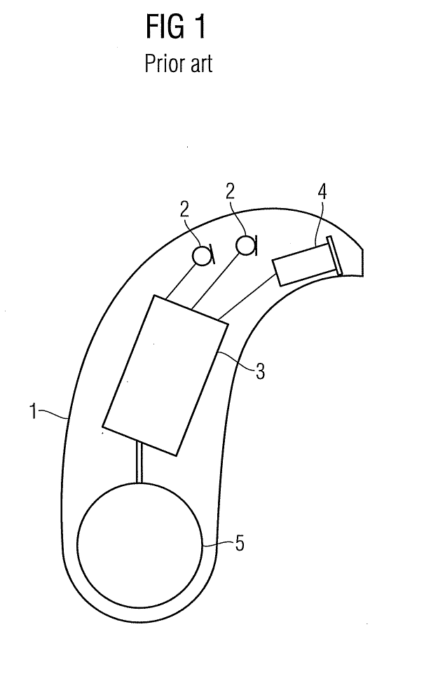

FIG. 2: a flowchart of an inventive cepstral modification and

FIG. 3: a flowchart of a further inventive cepstral modification.

### DETAILED DESCRIPTION OF THE INVENTION

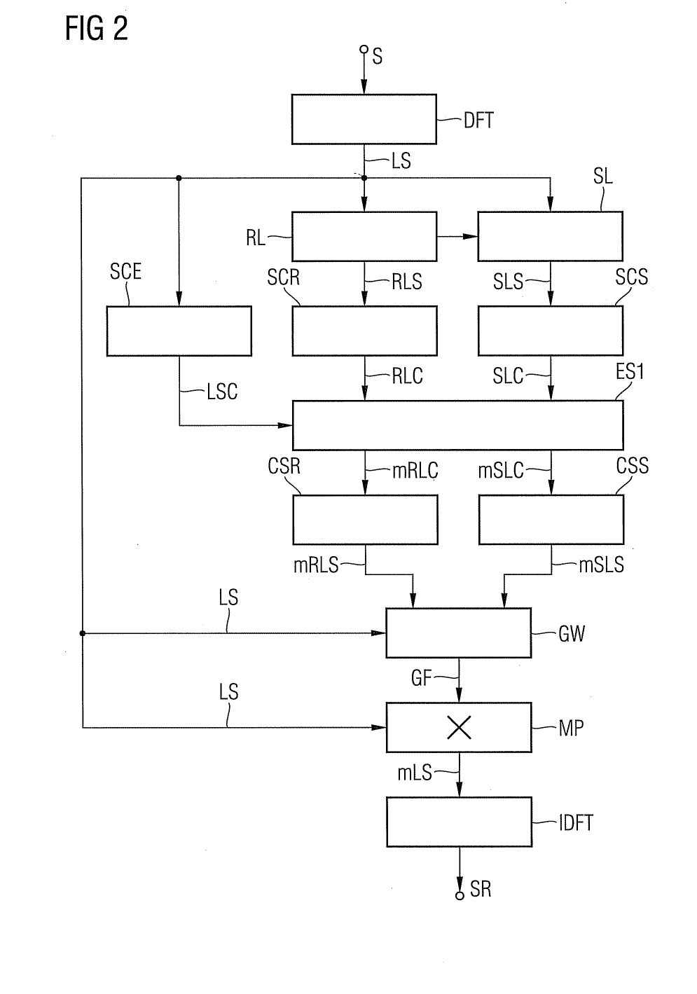

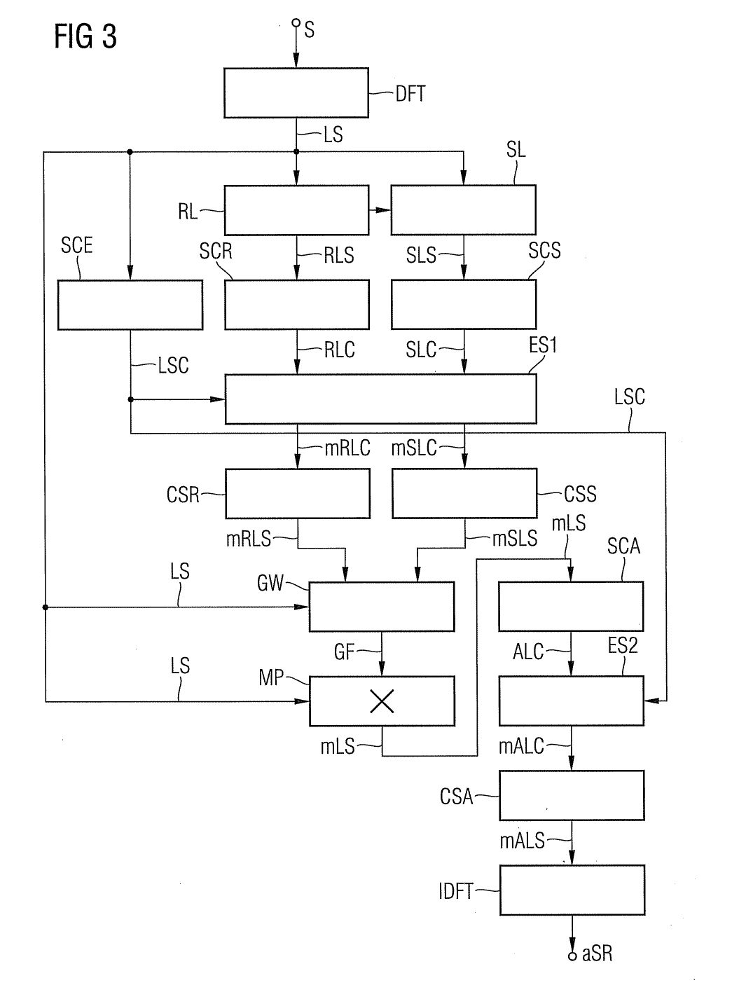

A general overview of the inventive method for noise reduction is first given below, before specific embodiments are examined with reference to FIGS. 2 and 3.

The cepstrum of an input speech signal s(t) overlaid with noises can be determined as follows. Assuming that a discrete time signal s(t) sampled with the sampling rate fₛ is given. This time signal is subdivided into segments of length M. The segments are offset from each other with an advance of R and are weighted with an analysis window. The discrete Fourier-transform of the segment, Sₖ(1), is indexed by the frequency index k and the segment index 1. The cepstrum is calculated from the inverse Fourier transformation of the logarithmized magnitude spectrum

s_{q}(1)=IDFT{log(|Sₖ(1)|)},

with q being the cepstral coefficient index, the so-called Quefrency index, and IDFT { } being the inverse discrete Fourier transformation.

Cepstral coefficient zero (q=0) gives information about the even proportion of the logarithmized magnitude spectrum. The lower cepstral coefficients contain the information about the envelope of the speech signal, and thus also about the formants important for the comprehensibility. Formants are identified a maxima of the spectral envelopes which result from the resonances of the vocal tract. With voiced sounds maxima at multiples of the basic voice frequency are to be found in the spectrum. These maxima are essentially mapped in the cepstrum onto one strong maximum. Thereafter the maxima contain the lower cepstral coefficients a maximum in the upper cepstral domain the information about speech, while the remaining cepstral coefficients very probably do not to originate from speech.

Some of the output signals of spectral noise reduction algorithms contain unnatural artifacts, for example peaks in the spectral domain which lead to so-called “Musical Noise”. These local spectral maxima change the fine structure of the spectrum, which is reflected in the upper cepstral bins. Since it is known in the cepstral domain which coefficients very probably do not originate from speech, this information can be used to avoid spectral outliers in the output signal. To this end the cepstral coefficients of certain parameters of the noise reduction algorithm are modified. The modification can be undertaken for example by a replacement of the cepstral coefficients which very probably do not originate from speech by the corresponding coefficients of the noise-affected signal.

The following three parameters are suitable for a cepstral modification:
The noise estimation, and/or
The speech power estimation, and/or
The noise-reduced output signal.

The flowchart of the inventive method for noise reduction shown in FIG. 2 could for example be converted in a signal processing unit of a hearing device. Via a wideband signal input an electrical signal S, which for example was obtained from an acoustic ambient signal, arrives in the signal processing unit. The input signal S is initially subjected to a discrete Fourier transformation DFT which splits up the input signal S into its spectral components with the spectral coefficients LS. By means of a noise power estimation RL and a speech power estimation SL the spectral coefficients RLS, SLS the noise power or the speech power is estimated.

From the spectral coefficients RLS, SLS thus obtained, by means of inverse Fourier transformation SCR, SCS of the logarithmized magnitude spectrum, the cepstra of the estimated noise power and speech power are formed. In this way the cepstral coefficients RLC, SLC are determined. From the spectrum of the input signal LS the cepstrum with the cepstral coefficients LSC is determined.

All three cepstra RLC, SLC, LSC are evaluated within the framework of a first replacement strategy ES1 and used for a modification of the cepstral coefficients RLC, SLC of the noise power or the speech power such that an optimum possible noise reduction of the input signal S and high naturalness of the output signal SR or aSR can be achieved. As the result of the first replacement strategy ES1 the modified cepstral coefficients mRLS, mSLS of the noise power and the speech are determined.

Modified spectral coefficients mRLS, mSLS of the noise power or the speech power are subsequently generated from the modified cepstral coefficients mRLC, mSLC by back transformations CSR, CSS. By means of a weighting method the weighting factors GF for the weighting of the spectral coefficients LS of the input signal are determined from the modified spectra mRLS, mSLS of the noise power and the speech power taking into account the spectrum LS of the input signal. With a subsequent multiplication MP the spectrum LS of the input signal is multiplied by the weighting factors. The modified spectral coefficients mLS thus produced are subsequently transformed by an inverse discrete Fourier transformation into a noise-reduced output signal SR.

Shown in FIG. 3 is the flowchart of a further embodiment of the inventive method. Up to the generation of modified spectral coefficients mLS from an input signal S the method is identical to that described in FIG. 2.

Before a back transformation in the time domain however the cepstrum with the cepstral coefficients ALS is formed from the noise-reduced spectrum mLS by means of inverse Fourier-Transformation SCA of the logarithmized magnitude spectrum. With the aid of a second replacement strategy ES2, which is intended to suppress artifacts, as well as taking into account the cepstrum LSC of the input signal S modified cepstral coefficients mALC of the noise-reduced output signal mLS are generated. Through a spectrum formation CSA modified spectral coefficients mALS are determined from them, which are subsequently transformed by an inverse discrete Fourier-transformation IDFT into an artifact-reduced output signal aSR.

The method steps shown can be implemented in accordance with the invention in a digital signal processor of a hearing device. In this way a high naturalness of an amplified sound signal with simultaneous noise reduction can be achieved. The cepstral modification transmits the fine structures present in the original noise-affected signal into the enhanced output signal and/or into the estimation of the speech power and/or into the estimation of the noise power, so that an enhanced naturalness is achieved and/or non-stationary noises are better mapped. The option of estimating rapidly changing noise makes this method extraordinarily interesting. Previously known methods merely achieve a reduction of the spectral fluctuations, but simultaneously reduce the fine timing structure.

### LIST OF REFERENCE SYMBOLS

1 Hearing device housing
2 Microphone
3 Signal processing unit
4 Earpiece
5 Battery
aSR Artifact-reduced output signal
CSA Spectrum formation
CSR Spectrum formation of the modified cepstrum of the noise power
CSS Spectrum formation of the modified cepstrum of the speech power
DFT Discrete Fourier Transformation
ES1 First replacement strategy
ES2 Second replacement strategy
GF Weighting factors
GW Determining the weighting of the spectral coefficients
IDFT Inverse Discrete Fourier Transformation
LS Spectral coefficients of the input signal S
LSC Cepstral coefficients of the input signal S
MP Multiplication
mALC Modified cepstral coefficients of the noise-reduced output signal mLS
mALS modified spectral coefficients
mLS Spectral coefficients of the noise-reduced input signal S
mRLC Modified cepstral coefficients of the noise power
mRLS Modified spectral coefficients of the noise power
mSLC Modified cepstral coefficients of the speech power
mSLS Modified spectral coefficients of the speech power
RL Noise power estimation
RLC Cepstral coefficients of the noise power
RLS Spectral coefficients of the noise power
S Input signal
SL Signal power estimation
SLC Cepstral coefficients of the speech power
SLS Spectral coefficients of the speech power
SCR Cepstrum formation from the spectrum of the noise power
SCS Cepstrum formation from the spectrum of the signal power
SCE Cepstrum formation from the spectrum of the input signal
SR Noise-reduced output signal

1.-7. (canceled)

8. A method for a noise reduction of an input signal of a hearing device, comprising:
generating a cepstral coefficient of the input signal;
modifying the cepstral coefficient of the input signal; and
generating a noise-reduced output signal from the input signal using the modified cepstral coefficient.

9. The method as claimed in claim 8, wherein the cepstral coefficient of the input signal is modified to a time-dependent cepstral coefficient replacement signal or a parameter derived from the replacement signal being transferred.

10. The method as claimed in claim 8, wherein the input signal is an acoustic signal and is picked up by the hearing device.

11. The method as claimed in claim 8, further comprising:
generating a spectral coefficient of a noise power by a noise estimation of the input signal;
determining a cepstral coefficient of the noise power from the spectral coefficient of the noise power;
determining a modified cepstral coefficient of the noise power using a first replacement strategy;
determining a modified spectral coefficient of the noise power from the modified cepstral coefficient of the noise power; and
generating the noise-reduced output signal by the modified spectral coefficient of the noise power.

12. The method as claimed in claim 11, further comprising:
generating a cepstral coefficient of the noise-reduced output signal;
determining a modified cepstral coefficient of the noise-reduced output signal using a second replacement strategy; and
generating a further noise-reduced output signal from the modified cepstral coefficient of the noise-reduced output signal.

13. The method as claimed in claim 8, further comprising:
generating a spectral coefficient of a speech power by a speech estimation of the input signal;
determining a cepstral coefficient of the speech power from the spectral coefficient of the speech power;
determining a modified cepstral coefficient of the speech power using a first replacement strategy;
determining a modified spectral coefficient of the speech power from the modified cepstral coefficient of the speech power; and
generating the noise-reduced output signal by the modified spectral coefficient of the speech power.

14. The method as claimed in claim 13, further comprising:
generating a cepstral coefficient of the noise-reduced output signal;
determining a modified cepstral coefficient of the noise-reduced output signal using a second replacement strategy; and
generating a further noise-reduced output signal from the modified cepstral coefficient of the noise-reduced output signal.

15. The method as claimed in claim 8, further comprising:
generating the cepstral coefficient of the input signal;
determining the modified cepstral coefficient of the input signal using a second replacement strategy; and
generating the noise-reduced output signal from the modified cepstral coefficient of the input signal.

16. A hearing device, comprising:
a signal processing unit comprising:
a power estimator that estimates a spectral coefficient of an input signal of the hearing device; and
a replacement unit that:
generates a cepstral coefficient of the input signal from the spectral coefficient,
modifies the cepstral coefficient of the input signal, and
generates a noise-reduced output signal from the input signal using the modified cepstral coefficient.

17. The hearing device as claimed in claim 16, wherein the power estimator comprises:
a noise power estimator that estimates a spectral coefficient of a noise power of the input signal, and
a speech power estimator that estimates a spectral coefficient of a speech power of the input signal.

18. The hearing device as claimed in claim 17, wherein the replacement unit comprises a first replacement unit that modifies a cepstral coefficient of the noise power from the spectral coefficient of the noise power and a cepstral coefficient of the speech power from the spectral coefficient of the speech power using a first replacement strategy.

19. The hearing device as claimed in claim 16, wherein the replacement unit comprises a second replacement unit that modifies the cepstral coefficient of the input signal using a second replacement strategy.

20. A computer program product executed on a hearing device for a noise reduction, comprising:
a computer program that:
estimates a spectral coefficient of an input signal of the hearing device,
generates a cepstral coefficient of the input signal from the spectral coefficient,
modifies the cepstral coefficient of the input signal, and
generates a noise-reduced output signal from the input signal using the modified cepstral coefficient.
